(19) United States
(12) Patent Application Publication
(10) Pub. No.: US 2023/0131616 A1
(43) Pub. Date: Apr. 27, 2023

(54) MULTI-USE MASSAGE TOOL

(71) Applicant: Jim Tracy Smith, Loyalton, CA (US)

(72) Inventor: Jim Tracy Smith, Loyalton, CA (US)

(21) Appl. No.: 17/508,707

(22) Filed: Oct. 22, 2021

(51) Int. Cl. A61H 15/00; A61H 7/00

(52) U.S. Cl. CPC A61H 15/0092; A61H 7/007; A61H 2015/0042; A61H 2201/0153; A61H 2201/169

(57) ABSTRACT

A massage tool includes a spherically-shaped muscle ball element, a cylindrical central handle element, a discoid-shaped skin brace element, and a pin-pointer element. The massage tool allows for both general and targeted massage of various body parts. For example, the spherically-shaped muscle ball element can be used for general massage to aid in relaxing muscles; and the pin-pointer element can be used for targeted massage of particularly tense muscle fibers (muscular knots). The cylindrical central handle element can also double as a shoulder roller for releasing tension in the shoulders.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of physical therapy of existing art and more specifically relates to a multi-use massage tool.

### Related Art

Tense muscles are an ever prevalent problem for many people that are triggered or aggravated by many factors. For example, common contributors to the development of stressed muscles and muscular knots include excessive sitting, poor posture, repetitive motion, mechanical imbalance, joint disorders, lack of sleep and vitamin deficiencies. Unfortunately, these contributing factors are often very difficult to change or prevent. For example, many jobs involve excessive sitting in front of computers which can subsequently lead to poor posture and lack of sleep. Untreated tense muscles often lead to chronic pain in the back, shoulders and neck, migraines, limited movement, risk of injury, etc. As such, it is important to routinely relieve tension in the muscles to prevent these consequences.

Massage is a well-known technique for relaxing stressed muscles. Whether self-massaging or receiving a massage, it is common to use massage tools to aid in targeting specific muscles. For example, foam rollers are often used for rolling out tense muscles, particularly before or after exercise. However, it would be useful, particularly for use in self-massaging, to have a multi-use massage tool that can be used for both general and targeted massaging of various body parts.

### SUMMARY OF THE INVENTION

In view of the foregoing disadvantages inherent in the known physical therapy tool art, the present disclosure provides a novel multi-use massage tool. The general purpose of the present disclosure, which will be described subsequently in greater detail, is to provide a massage tool that may be used for both general and targeted massaging of various body parts, as well as providing cold and/or heat therapy to the various body parts.

A massage tool is disclosed herein. The massage tool include may include a spherically-shaped muscle ball element, a cylindrical central handle element, a discoid-shaped skin brace element, and a pin-pointer element. The cylindrical central handle element may include a first end and a second end and the spherically-shaped muscle ball element may be fused to the first end of the cylindrical central handle element. The discoid-shaped skin brace element may include an inner central region opposite an outer central region and the inner central region of the discoid element may be fused to the second end of the cylindrical central handle element. The pin-pointer element may comprise a cylindrical portion and a semi-spherical cap portion. The cylindrical portion of the pin-pointer element may include an inner end and an outer end. The semi-spherical cap portion may be fused to the outer end of the cylindrical portion and the inner end of the cylindrical portion of the pin-pointer element may be fused to the outer central region of the skin brace element.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a multi-use massage tool, constructed and operative according to the teachings of the present disclosure.

FIG. 1 is a perspective view of a massage tool illustrating a spherically-shaped muscle ball element thereof being used to massage and relax muscles in an upper leg of a user, according to an embodiment of the disclosure.

FIG. 2 is a perspective view of the massage tool illustrating a pin-pointer element thereof being used to release muscle knots in a shoulder of the user, according to an embodiment of the disclosure.

FIG. 3 is a side rear perspective view of the massage tool illustrating a discoid-shaped skin brace element fused to a second end of a cylindrical central handle element and the pin-pointer element fused to the discoid-shaped skin brace element, according to an embodiment of the present disclosure.

FIG. 4 is a side front perspective view of the massage tool illustrating the spherically-shaped muscle ball element fused to a first end of the cylindrical central handle element, according to an embodiment of the present disclosure.

FIG. 5 is a front perspective view of the massage tool, according to an embodiment of the present disclosure.

FIG. 6 is a front view of the massage tool, according to an embodiment of the present disclosure.

FIG. 7 is a top view of the massage tool illustrating a size relationship between the spherically-shaped muscle ball element and the cylindrical central handle element, according to an embodiment of the present disclosure.

FIG. 8 is a top view of the massage tool illustrating a size relationship between the discoid-shaped skin brace element and the pin-pointer element, according to an embodiment of the present disclosure.

FIG. 9 is a top view of the massage tool illustrating a size relationship between the discoid-shaped skin brace element and the cylindrical central handle element, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to physical therapy and more particularly to a multi-use massage tool. Generally, the multi-use massage tool may include a handle which doubles as a shoulder roller, a muscle ball at one end of the handle and a pin-pointer and skin brace at another end of the handle. The handle may be used for gripping the multi-use massage tool and may also be used for releasing tension in the shoulders by rolling the handle thereover. The multi-use massage tool may be configured for massaging body parts of the user and particularly for relaxing muscles and releasing particularly tense muscle fibers (muscular knots).

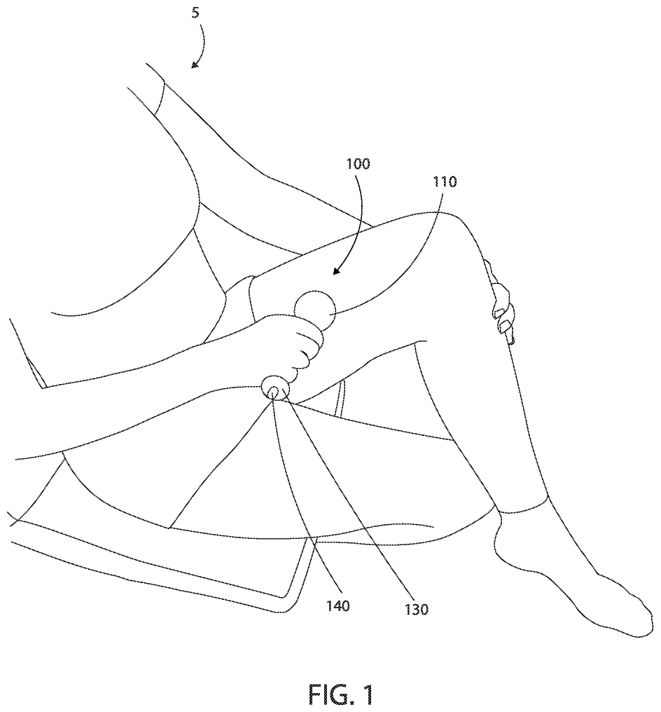

Referring now more specifically to the drawings by numerals of reference, there is shown in FIGS. 1-9, various views of a massage tool 100. As shown, the massage tool 100 may comprise a spherically-shaped muscle ball element 110, a cylindrical central handle element 120, a discoid-shaped skin brace element 130, and a pin-pointer element 140.

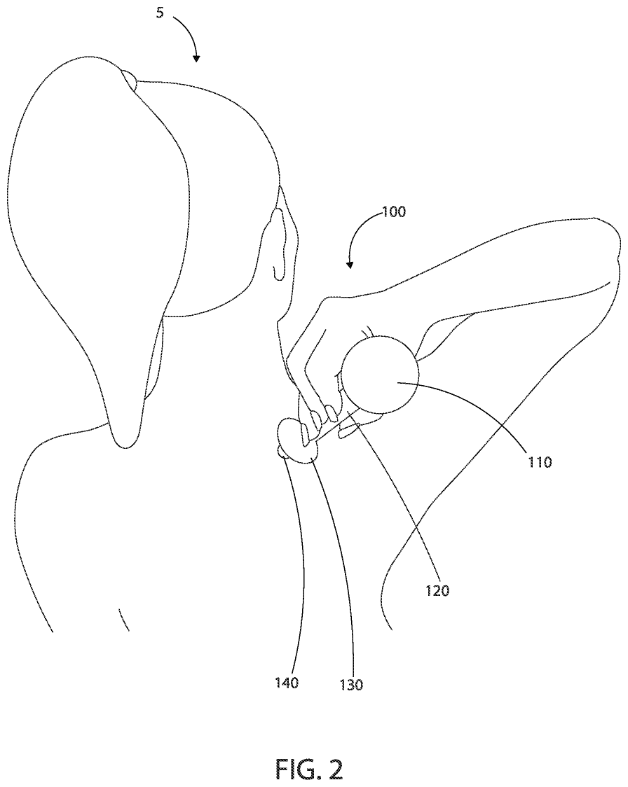

As shown in FIGS. 1-2, the massage tool 100 may be used for massaging body parts of a user 5, such as shoulders, scapula, upper and lower back of leg, upper front of leg, neck, arms, etc. Specifically, the spherically-shaped muscle ball element 110 may be used for generally massaging and relaxing muscles (for example in the upper leg as shown in FIG. 1), and the pin-pointer element 140 may be used for targeted massage to release stressful muscular knots (for example in the shoulders as shown in FIG. 2).

Preferably, the massage tool 100 may be made out of a thermally conductive material, allowing the massage tool 100 to be used for providing cold therapy and/or heat therapy. For example, the massage tool 100 may be made out of aluminum (however, it should be appreciated that the massage tool 100 is not limited to aluminum). In this embodiment, the massage tool 100 may be placed in cold or warm/hot water at a desired temperature prior to use. This may increase benefits of the massage tool 100. For example, when the massage tool 100 is at a cold temperature it may be particularly useful for pain relief. When the massage tool 100 is at a warm/hot temperature it may be particularly useful for stimulating blood flow.

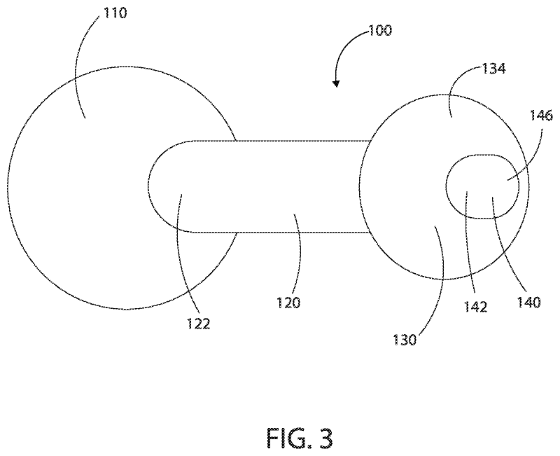

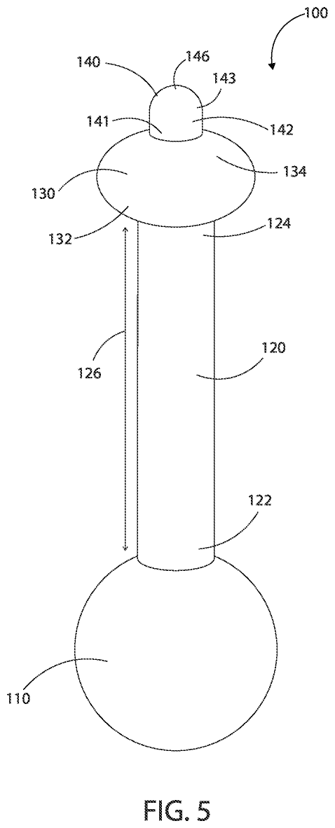

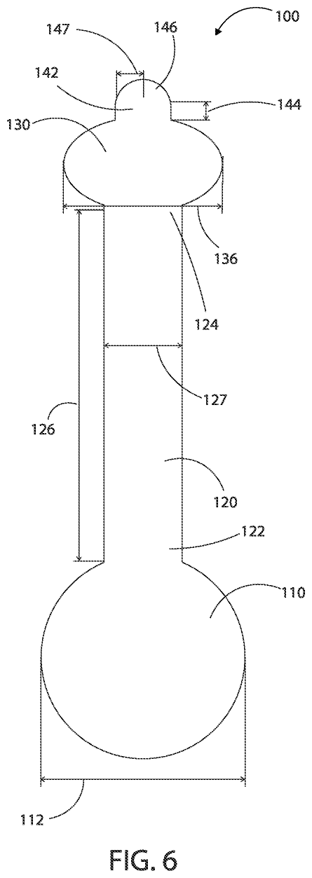

As shown in FIGS. 3-6, the cylindrical central handle element 120 may include a first end 122 and a second end 124. A length 126 of the cylindrical central handle element 120 (FIGS. 5-6) may allow the user 5 to comfortably grasp the massage tool 100 during use thereof. Further, in some embodiments, the cylindrical central handle element 120 may be utilized as a muscle roller for rolling out tense muscles. For example, the cylindrical central handle element 120 may be used as a shoulder roller. As such, the length 126 may also be sized to comfortably accommodate the shoulder of the user (or any other body part contemplated for use with the muscle roller). For example, the length 126 of the cylindrical central handle element 120 from the first end 122 to the second end 124 may be 4 inches.

As shown in FIGS. 3-5, the discoid-shaped skin brace element 130 may include an inner central region 132 opposite an outer central region 134. As shown, the inner central region 132 of the discoid-shaped skin brace element 130 may be fused to the second end 124 of the cylindrical central handle element 120. Further, the pin-pointer element 140 may be connected to the discoid-shaped skin brace element 130. As shown in FIGS. 5-6, the pin-pointer element 140 may comprise a cylindrical portion 142 and a semi-spherical cap portion 146. The cylindrical portion 142 of the pin-pointer element 140 may be in line with the cylindrical central handle element 120 and may include an inner end 141 and an outer end 143 (FIG. 5). Preferably, the inner end 141 of the cylindrical portion 142 of the pin-pointer element 140 may be fused to the outer central region 134 of the discoid-shaped skin brace element 130.

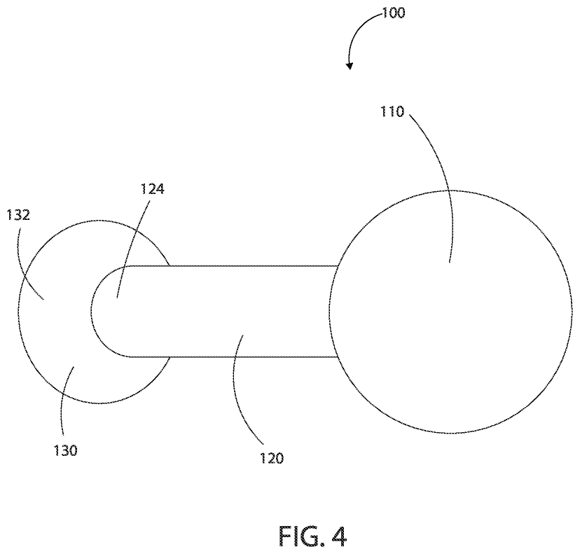

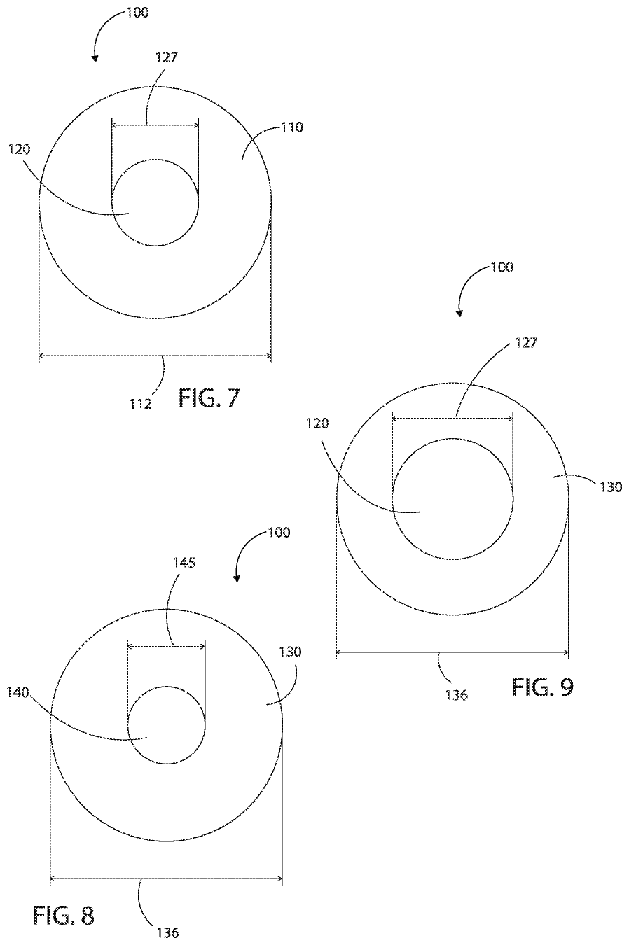

As shown in FIGS. 4-6, the spherically-shaped muscle ball element 110 may be fused to the first end 122 of the cylindrical central handle element 120. As above, the spherically-shaped muscle ball element 110 may be used for generally massaging and relaxing the muscles. As such, the spherically-shaped muscle ball element 110 may be sized to stimulate a large portion of a targeted muscle, providing maximum stimulation and relaxation thereof. For example, as demonstrated in FIG. 6-7, the spherically-shaped muscle ball element 110 may include a diameter 112 of 3 inches. A size relationship between the spherically-shaped muscle ball element 110 and the cylindrical central handle element 120 is shown in FIG. 7 to illustrate relative size of the spherically-shaped muscle ball element 110. As demonstrated in FIGS. 6-7, the cylindrical central handle element 120 may include a diameter 127 of 1 inch.

As discussed above, the pin-pointer element 140 may be used for targeted massage to release stressful muscular knots. As such, the pin-pointer element 140 may be sized to stimulate a small portion of the muscles in order to pinpoint the muscular knots. For example, as demonstrated in FIG. 6, the semi-spherical portion of the pin-pointer element 140 may include a radius 147 of ⅜ of an inch. Further, the cylindrical portion 142 of the pin-pointer element 140 may include a length 144 of 0.75 inches and as demonstrated in FIG. 8, a diameter 145 of 2 inches. The discoid-shaped skin brace element 130 may be configured to ‘brace’ skin of the user when the pin-pointer element 140 is being used. This may stabilize the pin-pointer element 140 on the body part and facilitate the use thereof. As such, the discoid-shaped skin brace element 130 may be sized to adequately brace the skin whilst not obstructing or otherwise hindering use of the pin-pointer element 140. For example, as demonstrated in FIG. 9, in some embodiments, the discoid-shaped skin brace element 130 may include a diameter 136 of 2 inches.

It should be appreciated that the measurements discussed above for the massage tool 100 are given as examples and that the massage tool 100 is not limited to these measurements.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The numbered list format used in the claims of the application is used solely for organizational purposes to provide clarity thereto and is not meant to limit in any way the claimed matter nor any aspect of the present disclosure.

What is claimed is:

1. A massage tool comprising:
a. a spherically-shaped muscle ball element;
b. a cylindrical central handle element having a first end and a second end;
c. a discoid-shaped skin brace element having an inner central region opposite an outer central region;
d. a pin-pointer element comprising a cylindrical portion and a semi-spherical cap portion, wherein the cylindrical portion of the pin-pointer element has an inner end and an outer end and the semi-spherical cap portion is fused to the outer end of the cylindrical portion;
e. the spherically-shaped muscle ball element is fused to a first end of the cylindrical central handle element;
f. the inner central region of the discoid element is fused to the second end of the cylindrical central handle element;
g. the inner end of the cylindrical portion of the pin-pointer element is fused to the outer central region of the skin brace element.

2. The massage tool of claim 1, wherein the massage tool is made out of aluminum.

3. The massage tool of claim 1, wherein the cylindrical portion of the pin-pointer element is in line with the central cylindrical handle element.

4. The massage tool of claim 1, wherein the spherically-shaped muscle ball element has a diameter of 3 inches.

5. The massage tool of claim 1, wherein the length of the cylindrical central element measured from the first end to the second end is 4 inches.

6. The massage tool of claim 1, wherein the discoid element has a diameter of 2 inches.

7. The massage tool of claim 1, wherein the cylindrical portion of the pin-pointer element has a length of 0.75 inches and a diameter of 2 inches.

8. The massage tool of claim 7, wherein the semi-spherical portion of the pin-pointer element has a radius of ⅜ of an inch.
